(19) United States
(12) Patent Application Publication
(10) Pub. No.: US 2025/0237929 A1
(43) Pub. Date: Jul. 24, 2025

(54) FLASH LIGHT EMITTING DEVICE, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: AZUSA SUGAWARA, Kanagawa (JP)

(21) Appl. No.: 19/011,943

(22) Filed: Jan. 7, 2025

(30) Foreign Application Priority Data
Jan. 19, 2024 (JP) 2024-006637

(51) Int. Cl. G03B 15/05; H04N 23/56; H05B 47/19

(52) U.S. Cl. CPC G03B 15/05; H04N 23/56; H05B 47/19

(57) ABSTRACT

A flash light emitting device that can reduce work load of setting a role configuration related to wireless communication. A light emitting unit emits flash light. A first communication unit communicates with an image capturing apparatus. A second communication unit wirelessly transmit and receive control information to and from another flash light emitting device. A setting unit sets, as a role configuration related to wireless communication, any one of a sender that transmits the control information, a receiver that receives the control information, and communication OFF. The setting unit changes the role configuration to the sender when the role configuration is the receiver and the first communication unit can communicate with the image capturing apparatus, and changes the role configuration to the receiver when the role configuration is the sender and the first communication unit cannot communicate with the image capturing apparatus.

### BACKGROUND

### Technical Field

One disclosed aspect of the embodiments relates to a flash light

emitting device, a control method therefor, and a storage medium storing a control program therefor.

### Description of the Related Art

Conventionally, wireless flash photography is known in which a plurality of flash light emitting devices are connected by wireless communication using light or radio waves, and the wirelessly connected flash light emitting devices are caused to synchronously emit light at a shutter timing of an image capturing apparatus.

Generally, connection setting of wireless communication needs to manually set two or more flash light emitting devices to be connected. Items to be set in the connection setting include a wireless role configuration (assignment of sender/receiver) indicating a role relating to wireless communication, a communication channel configuration, and further, a network ID configuration in radio wave wireless communication.

In wireless flash photography, since a master flash light emitting device needs to send an instruction of an emission timing to synchronize with a shutter timing of an image capturing apparatus to a slave flash light emitting device, the flash light emitting device mounted on the image capturing apparatus is necessarily the master device. If the manual setting of the wireless role configuration is required when a flash light emitting device is mounted on the image capturing apparatus, it is troublesome.

In view of this, Japanese Patent Laid-Open Publication No. 2000-89309 (JP 2000-89309A, One of priority applications of U.S. Pat. No. 6,404,987 B1) discloses a technique for changing a wireless role configuration in association with mounting of a flash light emitting device to an image capturing apparatus. In this technique, when a flash light emitting device set as a receiver is connected to an image capturing apparatus and communication detection is performed, a mode is changed to a mode in which normal light emission is possible. Thus, the flash light emitting device set as the receiver can always emit flash light when connected to the image capturing apparatus.

However, the change of the wireless role configuration disclosed in the above publication is limited to the operation in a state where the flash light emitting apparatus is set as the receiver, and does not achieve an automatic setting of the wireless role configuration regardless of the state of the flash light emitting apparatus. Therefore, there is room for improvement in reducing the work load of the setting of the wireless role configuration.

### SUMMARY

Accordingly, an aspect of the present disclosure provides a flash light emitting device detachable from an image capturing apparatus, the flash light emitting device including a light emitting unit configured to emit flash light, at least one processor, and a memory coupled to the processor storing instructions that, when executed by the processor, cause the processor to function as: a first communication unit configured to communicate with the image capturing apparatus via a mount, a second communication unit configured to wirelessly transmit and receive control information to and from another flash light emitting device, and a setting unit configured to set, as a role configuration related to wireless communication by the second communication unit, any one of a sender that transmits the control information to the other flash light emitting device, a receiver that receives the control information from the other flash light emitting device, and communication OFF that does not perform wireless communication with the other flash light emitting device. The setting unit changes the role configuration to the sender in a case where the role configuration is the receiver and it is determined that the communication with the image capturing apparatus by the first communication unit is possible, and changes the role configuration to the receiver in a case where the role configuration is the sender and it is determined that the communication with the image capturing apparatus by the first communication unit is impossible.

According to the disclosure, it is possible to reduce the work load of the role configuration related to wireless communication.

Further features of the present disclosure will become apparent from the following description of exemplary embodiments with reference to the attached drawings.

### BRIEF DESCRIPTION OF THE DRAWINGS

FIG. 1 is a schematic view showing a wireless flash photography system.

FIG. 2 is a block diagram showing the wireless flash photography system.

FIG. 3A and FIG. 3B are front views of a flash.

FIG. 4 is a flowchart showing an automatic wireless role setting process.

FIG. 5 is a flowchart showing a manual wireless role setting process.

FIG. 6 is a flowchart showing a pairing process.

FIG. 7 is a flowchart showing a manual wireless role setting process.

### DESCRIPTION OF THE EMBODIMENTS

Hereafter, embodiments according to the present disclosure will be described in detail by referring to the drawings.

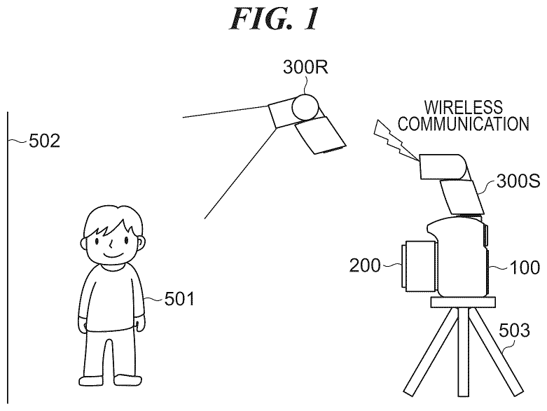

FIG. 1 is a schematic view showing a wireless flash photography system to which a flash light emitting device according to a first embodiment is applied.

There are flash devices 300S and 300R as examples of the flash light emitting devices. The flash devices 300S and 300R may be referred to as strobes. The wireless flash photography system includes a camera 100, which is an image capturing apparatus body, a lens unit 200, the flash device 300S directly mounted to the camera 100, and the flash device 300R independent of the camera 100.

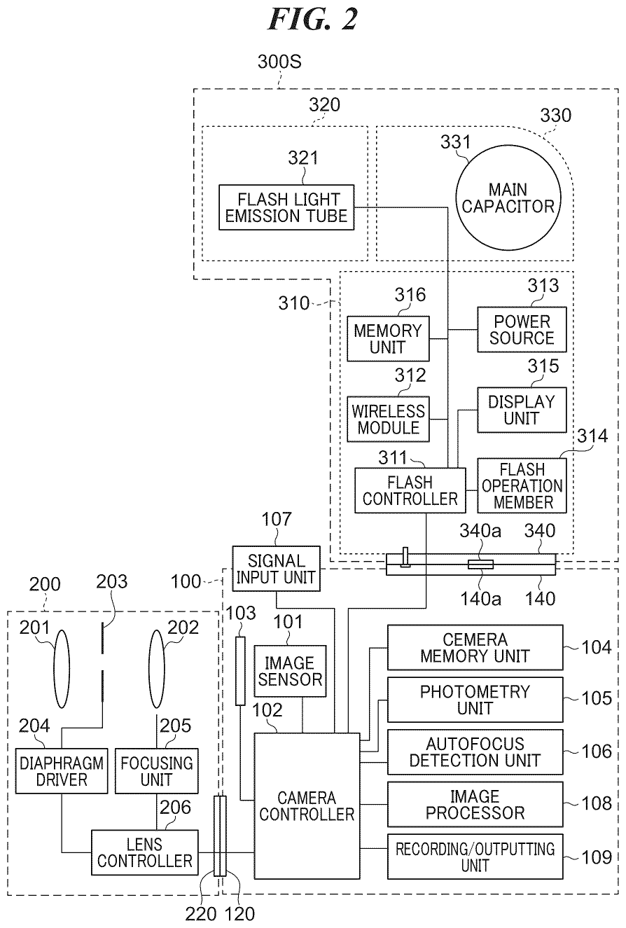

The flash devices 300S and 300R communicate wirelessly with each other by a wireless module 312 (FIG. 2) described below. The flash device 300S and the flash device 300R may be the same model or different models as long as they can wirelessly communicate with each other.

FIG. 1 shows a state that assumes flash photography in a photo studio, and the camera 100 is secured by a tripod 503 and faces an object 501 and a screen 502. In the present embodiment, the flash device 300S connected to the camera 100 serves as a master unit, and the flash device 300R independent of the camera 100 serves as a slave unit, thereby flash synchronization photography in which a light emission timing is synchronized with a shutter timing of the camera 100 is achieved.

FIG. 2 is a block diagram showing the wireless flash photography system. This system includes the camera 100, the lens unit 200 that is attachable to and detachable from the camera 100, and the flash device 300S that is attachable to and detachable from the camera 100. It is not essential that the image capturing apparatus body and the lens unit are separately configured, and it is also applicable to an image capturing apparatus in which the image capturing apparatus body and the lens unit are integrally configured. The plurality of flash devices 300S and 300R shall have the same configuration.

The camera 100 includes an image sensor 101, such as a CCD sensor or a CMOS sensor. The image sensor 101 photoelectrically converts an optical image formed on an imaging surface of the image sensor 101 by an optical system of the lens unit 200, and outputs an obtained analog image signal to an A/D converter as image data.

A shutter 103 is provided on an optical path of light incident via the lens unit 200 to control an exposure state of the image sensor 101. The shutter 103 is in a closed state to shield the image sensor 101 from light when an image is not captured, and is in an open state when an image is capturing (when live view is performed, when a still image is capturing, or when a still image is obtaining) to guide incident light to the image sensor 101. The operation of the shutter 103 is controlled by a camera controller 102, and the opening and closing of the shutter 103 is controlled in accordance with the exposure time determined for image capturing. Although the configuration in which exposure control of the image sensor 101 is performed by a what is called mechanical shutter is shown in the example in FIG. 2, the exposure control may be achieved by a what is called electronic shutter achieved by accumulation control of the image sensor 101. The camera controller 102 reads a control program for each block

included in the camera 100 from a ROM (not shown) included in a camera memory unit 104, and develops the control program to a RAM (not shown) included in the camera memory unit 104 to execute the control program. Thus, the camera controller 102 controls the operation of each block included in the camera 100, and can perform overall control of the camera 100 and the lens unit 200. The camera controller 102 is connected to the shutter 103, a photometry unit 105, an automatic focus detection unit 106, a signal input unit 107, an image processor 108, a recording/output unit 109, a camera mount 120, and a camera-side ACC mount 140.

The camera controller 102 transmits signals to a focusing unit 205 and a diaphragm driver 204 in the lens unit 200 via the camera mount 120, a lens mount 220 in the lens unit 200, and a lens controller 206.

The photometry unit 105 can perform amplification, logarithmic compression, A/D conversion, etc. of a signal obtained from the image sensor 101 that also serves as a photometric sensor, specifically, a luminance signal corresponding to brightness of an object field, and obtain a result as object field luminance information.

An autofocus detection unit 106 performs A/D conversion of signal voltages from detection elements (pixels) included in pixels constituting the image sensor 101 and used for phase difference detection. Then, the camera controller 102 calculates the distance to an object corresponding to each focus detection point from the converted signals of the detection elements. This is a known technique known as image plane phase difference AF.

The image processor 108 performs various image processes to the image data stored in the RAM. Specifically, the image processor 108 executes various image processes for developing, displaying, and recording digital image data, such as a correction process for a pixel defect due to the optical system or the image sensor, a demosaicing process, a white balance correction process, a color interpolation process, and a gamma process.

The signal input unit 107 is, for example, a release button, and includes a switch SW1 that turns ON in a first stroke and a switch SW2 that turns ON in a second stroke. When the switch SW1 turns ON, the start of photometry and distance measurement of the camera 100 is instructed, and when the switch SW2 turns ON, the start of the image capturing operation is transmitted to the camera controller 102.

The recording/output unit 109 records the data including the image data in a recording medium such as a detachable memory card, and outputs the recorded data to an external device via an external interface.

The flash device 300S is physically mounted on the camera 100 by connecting the camera-side ACC mount 140 of the camera 100 and a flash-side ACC mount 340 of the flash device 300S. The flash-side ACC mount 340 is an example of a “mount” that detachably mounts the flash device 300S on the camera 100.

The camera-side ACC mount 140 includes a communication terminal 140a and the flash-side ACC mount 340 includes a communication terminal 340a. When the flash device 300S is mounted on the camera 100, the camera 100 and the lens unit 200 can communicate with each other via the communication terminals 140a and 340a of the ACC mounts 140 and 340. The communication terminal 340a serves as a first communication unit that communicates with the camera 100 via the flash-side ACC mount 340. When an instruction signal from the camera controller 102 is transmitted to a flash controller 311, flash emission by a flashlight emission tube 321, which will be described later, is controlled according to an instruction from the flash controller 311 that has received the instruction signal.

The lens unit 200 has the optical system including a zoom lens 201, a focus lens 202, a diaphragm 203, and the like. The lens unit 200 guides the light flux from the object to the image sensor 101 in the state of being mounted on the camera 100, and forms an object image on the imaging surface of the image sensor 101.

The lens controller 206 receives the instruction signal from the camera controller 102 via mount contacts (not shown) provided in the camera mount 120 and the lens mount 220. The diaphragm driver 204 and the focusing unit 205 are driven controlled by an instruction from the lens controller 206. The configuration of the flash device 300S will now be described.

The flash device 300S is roughly composed of a flash body 310, a flash head 320, and a bouncing mechanism 330.

The flash body 310 includes a main substrate (not shown) on which the flash controller 311 etc. for controlling the entire flash device 300S are mounted. The flash body 310 includes the wireless module 312, a power source 313, a flash operation member 314 including a power switch, a display unit 315, a memory unit 316, and the flash-side ACC mount 340.

The flash controller 311 mutually communicates with the camera controller 102 through the communication terminal 340a provided in the flash-side ACC mount 340, and controls flash light emission in response to a light emission instruction from the camera controller 102 or an instruction from the flash operation member 314.

The memory unit 316 stores a change history of the wireless role configuration (described later) that is set. The memory unit 316 includes an area for storing a state of “communicating/non-communicating” and a state of “automatic change/manual change” that are changed when the wireless role configuration is changed.

The wireless module 312 includes an antenna (not shown) and performs wireless communication with the other flash device 300R equipped with the wireless module 312 via the antenna by a method such as IEEE802.15.4, which is a known wireless communication standard. Therefore, the wireless module 312 is an example of a “second communication unit” that wirelessly transmits and receives control information to and from the other flash device 300R.

The flash controller 311 transmits information to control a light emission timing and a light emission amount to the other flash device 300R via the wireless module 312. The bounce mechanism 330 is a known irradiation direction changing mechanism in an external flash device. The bounce mechanism 330 holds the flash head 320 so as to be rotatable in a horizontal direction and a vertical direction with respect to the flash body 310, and thus can perform bounce photography in which the irradiation direction of the flash light emission is changed. The bounce mechanism 330 houses a main capacitor 331. A booster circuit (not shown) boosts the voltage of the power source 313 to several hundred volts and charges electric energy to the main capacitor 331. A resistor for detecting the voltage of the main capacitor 331 is incorporated in a part of the booster circuit.

The flash head 320 houses the flashlight emission tube 321 necessary for flash emission. The flashlight emission tube 321 is an example of a “light emitting unit” that emits flash light. The flashlight emission tube 321 is a xenon tube or a quartz tube, and emits flash light by converting electric energy charged in the main capacitor 331 into light energy in accordance with the light emission signal from the flash controller 311. A reflecting ambarella and a Fresnel lens (not shown) are arranged around the flashlight emission tube 321 to adjust the light distribution.

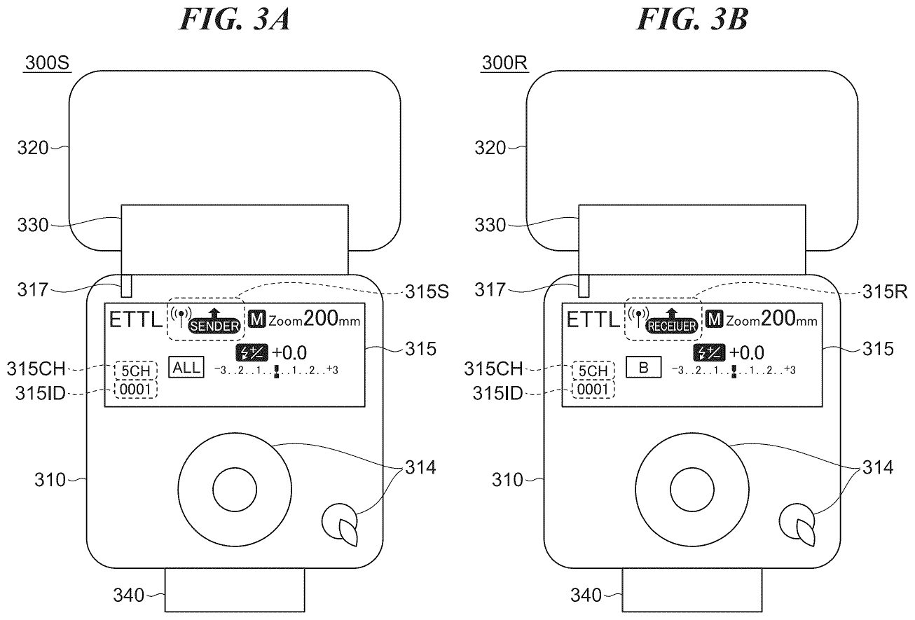

Next, various configurations for wirelessly connecting the flash devices will be described with reference to FIG. 3A and FIG. 3B. FIG. 3A and FIG. 3B are front views of the flash devices 300S and 300R, respectively. The flash device 300S and the flash device 300R are different mainly in display contents on the display units 315.

In the setting related to the radio wave wireless communication in the flash device, it is necessary to set three configurations including the wireless role configuration, a communication channel configuration, and a network ID configuration. The wireless role configuration is a configuration indicating a role related to the wireless communication by the wireless modules 312, and is switchable among sender, receiver, and wireless connection OFF. The sender is the configuration in which the flash device 300S becomes a device that transmits control information to the other flash device 300R. The receiver is the configuration in which the flash device 300R receives control information from the other flash device 300S. The wireless connection OFF (communication OFF) is a configuration in which the wireless communication with the other flash device 300R is not performed. The flash controller 311 as a setting unit sets any one of these as the wireless role configuration.

The flash device 300S set as the sender plays a role of communicating with the camera 100 and sending the light emission timing synchronized with the shutter of the camera 100 and the light emission amount to the other surrounding flash device 300R as instructions. The flash device 300R set as the receiver is arranged at a position away from the camera 100, and emits light in synchronization with an instruction from the flash device 300S set as the sender. The flash device 300S in the wireless connection OFF state does not perform wireless communication with the other flash device 300R.

The communication channel configuration (hereinafter, referred to as a CH configuration) is a configuration for designating a frequency band to be used, and is set to match a frequency channel of the flash device 300S set as the sender and a frequency channel of the flash device 300R set as the receiver. In recent years, there are many devices equipped with wireless communication methods of 2.4 GHz band, such as Wi-Fi (registered trademark), Zigbee (registered trademark), and Bluetooth Low Energy (registered trademark). Since these may cause communication interference and make the wireless connection unstable, it is necessary to set the CH configuration by avoiding the frequency channel in which the wireless connections are crossed.

The network ID configuration (hereinafter referred to as an ID configuration) is a configuration to identify a wireless network to be participated and is set to match the ID configuration of the flash device 300S set as the sender and the ID configuration of the flash device 300R set as the receiver. By setting the same network ID, the flash devices 300S and 300R can perform mutual wireless communication.

As shown in FIG. 3A, an icon 315S indicating sender is displayed on the display unit 315 of the flash device 300S set as the sender. As shown in FIG. 3B, an icon 315R indicating receiver is displayed on the display unit 315 of the flash device 300R set as the receiver. Also, a frequency channel 315CH and a network ID 315ID are also displayed on each display device 315.

The flash operation member 314 includes a dial, a cross key, a determination button, and a power slide switch. A user can transitions to a screen of each wireless connection configuration and perform a setting and a changing operation by moving a cursor position to a setting display of each wireless connection displayed on the display unit 315 and operating the determination button.

An LED 317 is controlled to light when a wireless communication link is established between the flash device 300S and the flash device 300R. If the wireless communication link is not established, the LED 317 is controlled to blink or to light in a color different from the color in the case where the link is established. With such a configuration, the LED317 can notify the user of the link state of the wireless communication.

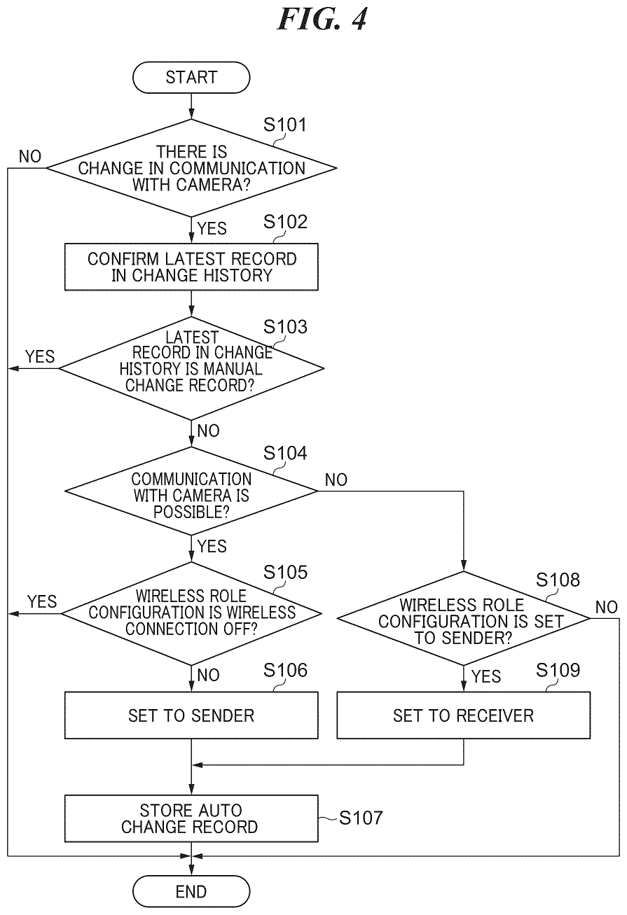

FIG. 4 is a flowchart showing an automatic wireless role setting process. This process is achieved by a CPU (not shown) of the flash controller 311 loading a program stored in a ROM (not shown) of the memory unit 316 into a RAM (not shown) of the memory unit 316 and executing the program.

This process is started when the flash device 300S is attached to or detached from the camera 100 or when the flash device 300S is powered ON. The attachment/detachment to/from the camera 100 may be detected by the conduction/non-conduction between the communication terminal 140a and the communication terminal 340a, or may be detected by another sensor. In addition, the above process may be executed when a signal is received from the camera 100 by turning on the switch SW1, or at predetermined time intervals. Note that the wireless role configuration is automatically set by the process in FIG. 4, but the user manually sets the ID configuration and the CH configuration.

In a step S101, the flash controller 311 determines whether there is a change in the communication state (the state of communication via the communication terminals 340a and 140a) with the camera controller 102 of the camera 100. For example, when the flash device 300S is mounted on the camera 100 and communication is started, or when the flash device 300S is removed from the camera 100 and communication is lost, it is determined that the communication state is changed.

As a result of the determination in the step S101, when there is no change in the communication state with the camera 100, the present process is terminated. On the other hand, when there is a change in the communication state with the camera 100, the process proceeds to a step S102.

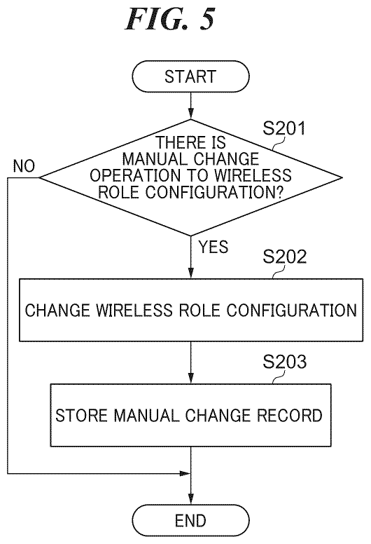

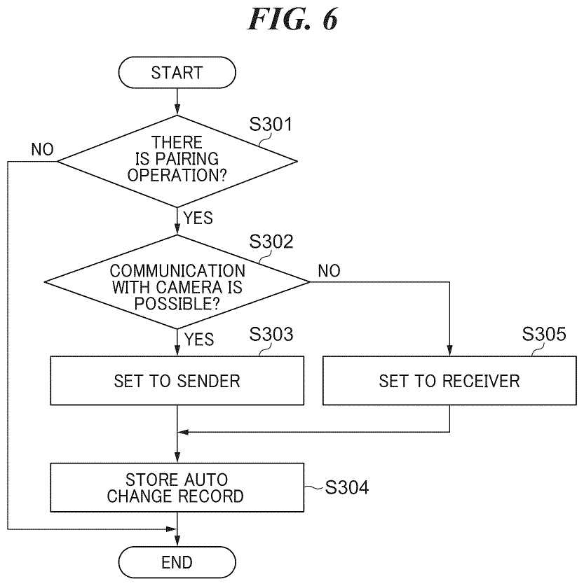

In the step S102, the Flash controller 311 confirms the latest record in the change history of the wireless role configuration stored in the memory unit 316. As will be described in detail later, the change history of the wireless role configuration includes an auto change record and a manual change record. The auto change record is stored in a step S107 or a step S304 in FIG. 6, and the manual change record is stored in a step S203 in FIG. 5. The latest record in the change history is information that is stored in the memory unit 316 as the latest record in the change history of the wireless role configuration.

In a step S103, the flash controller 311 determines whether the latest record in the change history stored in the memory unit 316 is a manual change record. When the latest record in the change history is a manual change record, the flash controller 311 ends this process because this indicates that an interrupt of manual change of the wireless role configuration has occurred. On the other hand, when the latest record in the change history is not a manual change record, the flash controller 311 proceeds with the process to a step S104.

In the step S104, the flash controller 311 determines whether communication with the camera controller 102 of the camera 100 (hereinafter referred to as ACC communication to be distinguished from wireless communication with the flash device 300R) is possible. Here, when the flash-side ACC mount 340 of the flash device 300S is attached to the camera-side ACC mount 140 and communication through the communication terminals 140a and 340a is established, it is determined that the ACC communication is possible. This means that the flash device 300S is in communication with the camera 100.

Then, the flash controller 311 proceeds with the process to a step S105 when the ACC communication is possible. However, when the ACC communication is impossible, the flash controller 311 determines that the flash device 300S is located at a position away from the camera 100 and proceeds with the process to a step S108.

In the step S105, the flash controller 311 determines whether the current wireless role configuration is the wireless connection OFF. Then, when the current wireless role configuration is the wireless connection OFF, the flash controller 311 ends this processing. Thus, the wireless connection OFF state is maintained. On the other hand, when the current wireless role configuration is not the wireless connection OFF, the flash controller 311 proceeds with the process to a step S106.

In the step S106, the flash controller 311 sets the wireless role configuration to the sender. Therefore, when the wireless role configuration is the sender, the configuration is maintained, and when the wireless role configuration is the receiver, the configuration is automatically changed to the sender.

In the step S107, the content of the wireless role configuration and the auto change record of the wireless role configuration are saved in the memory unit 316. Therefore, when the process is shifted from the step S106, the fact that the wireless role configuration has been automatically changed (including the case of maintaining the sender) during the communication with the camera 100 is stored.

On the other hand, in the step S108, the flash controller 311 is not communicating with the camera 100, and therefore the flash controller 311 determines whether the current wireless role configuration is the sender. If the current wireless role configuration is not the sender (is the receiver or wireless connection OFF), the flash controller 311 ends this process. This maintains the receiver or wireless connection OFF.

On the other hand, when the current wireless role configuration is the sender, the flash controller 311 proceeds with the process to a step S109, changes the wireless role configuration from the sender to the receiver, and proceeds with the process to the step S107. When the process is shifted from a step S109 to the step S107, the fact that the wireless role configuration is automatically changed to the receiver during non-communication with the camera 100 is stored. Therefore, every time wireless role configuration is automatically changed, the latest record in the change history is updated. After the step S107, the flash controller 311 ends the present process.

In this way, when the wireless role configuration is the sender or receiver, it can be determined that the user intends to perform the wireless photography. Therefore, when the ACC communication is possible, the wireless role configuration is set to the sender (S106). On the other hand, if the wireless role configuration is the sender when the ACC communication is disconnected (released), the wireless role configuration is changed from the sender to the receiver (S109).

This is because, in the wireless flash photography, it is appropriate that a flash device connected to the camera serves as a master unit and a flash arranged at a position away from the camera serves as a slave unit, and therefore, the master unit is set as the sender and the slave unit is set as the receiver. For example, when the user has an intention to perform the wireless flash photography in advance, the wireless connection configuration is not automatically changed to the wireless connection OFF. Thus, the wireless role setting is supported by taking the intention of the user.

FIG. 5 is a flowchart showing a manual wireless role setting process. The execution subject of this process is the same as that of the automatic wireless role setting process (FIG. 4). This process is started in response to, for example, an operation to start manual change of the wireless role configuration to the flash operation member 314. This process can be executed by interruption even during the execution of the automatic wireless role setting process (FIG. 4).

In a step S201, the flash controller 311 determines whether there is a manual change operation of the wireless role configuration by the user. The flash controller 311 can set the wireless role configuration based on a user instruction. For example, the user can instruct the change of the wireless role configuration by operating the flash operation member 314 and changing the item of the wireless role configuration displayed on the display unit 315. Then, the flash controller 311 ends this process when there is no manual change operation of the wireless role configuration. On the other hand, the flash controller 311 proceeds with the process to a step S202 when there is a manual change operation of the wireless role configuration.

In the step S202, the flash controller 311 changes the content of the wireless role configuration according to the manual change operation. In the step S203, the flash controller 311 stores the content of the manually changed wireless role configuration and the manual change record of the wireless role configuration in the memory unit 316. Note that the manual change record also stores information indicating whether the flash controller 311 is communicating or is not communicating with the camera 100 in association. Thus, whenever the wireless role configuration is manually changed, the latest record in the change history is updated. Thereafter, the flash controller 311 ends the present process.

The latest record in the change history is used in the determination in the step S103. According to the automatic wireless role setting process (FIG. 4), in principle, the flash device 300S mounted on the camera 100 automatically becomes the sender. On the other hand, the manual change operation is an operation that the user is performed with intention. Therefore, as described above, when the latest record in the change history is the manual change record in the step S103, the current wireless role configuration is maintained. That is, when the manual change operation is performed, the result of the interruption process is prioritized. Therefore, even when the flash device mounts on the camera 100 or even after the mounting on the camera 100 is released, the setting by the manual change operation is respected.

FIG. 6 is a flowchart showing a pairing process. The execution subject of this process is the same as that of the automatic wireless role setting process (FIG. 4). This process is started in response to, for example, an operation to start pairing to the flash operation member 314. This process can be executed by interruption even during the execution of the automatic wireless role setting process (FIG. 4).

The pairing is a known technique to automatically match the CH configurations and the ID configurations when flash devices to be connected are placed close to each other and a pairing operation of each flash device is started. In the pairing, the user operates the flash operation member 314 of the flash devices 300S and 300R placed in the vicinity within 1m, for example, and performs a pairing start operation of each flash device. For example, when the pairing is started, the receiver is notified of the CH configuration and the ID configuration of the sender, and the same CH configuration and ID configuration are set in both sides. Conventionally, a user needs to manually set the wireless role configurations (sender/receiver) by oneself before the pairing is started. On the other hand, the pairing process (FIG. 6) enables automatic setting of the wireless role configuration simultaneously with the pairing setting.

In a step S301, the flash controller 311 determines whether there is a pairing operation to the flash operation member 314. When there is no pairing operation, the flash controller 311 ends this process. When there is a pairing operation, the flash controller 311 proceeds with the process to a step S302.

In the step S302, the flash controller 311 determines whether the ACC communication with the camera controller 102 is possible as with the step S104. When the ACC communication is possible, the flash controller 311 proceeds with the process to a step S303. However, when the ACC communication is impossible, the flash controller 311 determines that the flash is located away from the camera 100 and proceeds with the process to a step S305.

In the step S303, the flash controller 311 sets the wireless role configuration to the sender and proceeds to step S304. In the step S305, the flash controller 311 sets the wireless role configuration to the receiver and proceeds with the process to the step S304.

The content of the wireless role configuration set in the step S303 or S305, the information indicating whether the flash controller 311 is communicating or is not communicating with the camera 100, and the auto change record of the wireless role configuration are stored in the memory unit 316 in the step S304, and the present process is terminated.

In this way, when the pairing operation is performed, the sender/receiver can be set based on whether communication with the camera 100 is possible, and thus it is possible to save the user the trouble of setting the sender/receiver in advance.

According to the present embodiment, when the start of the ACC communication with the camera 100 through the communication terminals 140a and 340a is confirmed, and when the wireless role configuration is the receiver, the wireless role configuration is changed to the sender (S106). When the release of the ACC communication is confirmed, and when the wireless role configuration is the sender, the wireless role configuration is changed to the receiver (S109). This basically automates the wireless role setting and reduces the burden on the user. Therefore, it is possible to reduce the burden of role setting related to the wireless communication.

Except for the case where the latest record in the change history is the manual change record, unless the wireless role configuration is the wireless connection OFF, the wireless role configuration becomes the sender when the start of the ACC communication is confirmed (S104 to S105 to S106). That is, the flash device 300S is set to the sender when it is mounted on the camera 100. From this viewpoint, the burden of the role setting related to the wireless communication can be reduced.

In addition, in a case where the start of the ACC communication is confirmed, when the wireless role configuration is the sender or the wireless connection OFF, the wireless role configuration is maintained as-is (S105, S106). In addition, in a case where the ACC communication release is confirmed, when the wireless role configuration is the receiver or the wireless connection OFF (No in S108), the wireless role configuration is maintained as-is. Thus, the wireless role setting is supported by taking the intention of the user.

In addition, in a case where change in the communication state with the camera 100 is confirmed, when the latest record in the change history stored in the memory unit 316 is the manual change record (set based on the user instruction (Yes in S103)), the wireless role configuration indicated by the latest record in the change history is maintained as-is. This allows to respect the manual setting of the wireless role configuration in accordance with the intention of the user.

Further, when the pairing is instructed during communication with the camera 100, the wireless role configuration is set to the sender, and when the pairing is instructed during non-communication with the camera 100, the wireless role configuration is set to the receiver. This can eliminate the need for the manual setting of the wireless role by the user in the pairing.

It should be noted that the display device 315 is not necessarily used for the pairing operation. For example, if the flash operation member 314 has a button dedicated to the pairing, the button may be used to set the sender/receiver together with the settings of the CH configuration and the ID configuration.

In addition, the automatic change of the wireless role configuration may be triggered by a setting operation of the CH configuration or ID configuration, not limited to the pairing operation.

The manual wireless role setting process (FIG. 5) and the pairing process (FIG. 6) may be independently executed without being limited to the interrupt process during the execution of the automatic wireless role setting process (FIG. 4).

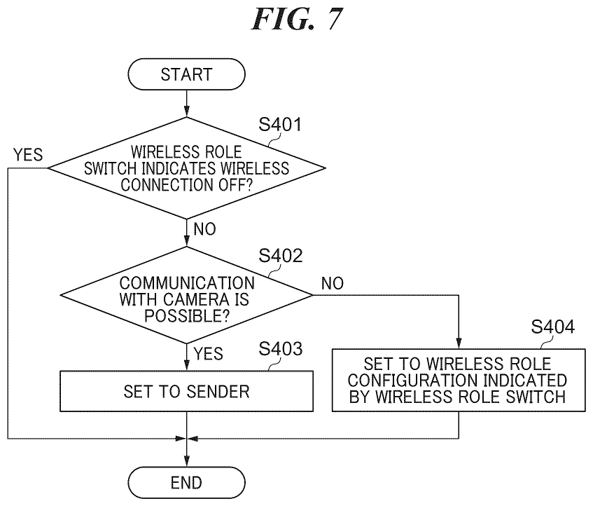

FIG. 7 is a flowchart of a manual wireless role setting process in a second embodiment. The execution subject and the start condition of this process are the same as that of the automatic wireless role setting process (FIG. 4).

In the present embodiment, the automatic wireless role setting process is different from that of the first embodiment, and other configurations (FIG. 1, FIG. 2, FIG. 3A, FIG. 3B, etc.) are the same. Note that the manual wireless role setting process (FIG. 5) and/or the pairing process (FIG. 6) may be used in combination.

The flash operation member 314 (FIG. 2, FIG. 3A, FIG. 3B) includes a wireless role switch that is an operation member operated by a user. The wireless role switch may be configured by, for example, providing the power slide switch included in the flash operation member 314 with four positions of the power OFF, the wireless connection OFF, the receiver, and the sender. Alternatively, the wireless role switch may be a slide switch dedicated to wireless role setting having three independent positions of the wireless connection OFF, the receiver, and the sender. For example, the position of the wireless role switch indicates the wireless role configuration that the user wants to set.

In a step S401, the flash controller 311 determines whether the wireless role configuration indicated by the wireless role switch of the flash operation member 314 is the wireless connection OFF. Then, when the wireless role configuration indicated by the wireless role switch is the wireless connection OFF, the flash controller 311 ends this process. Therefore, when the wireless role switch indicates the wireless connection OFF, the wireless role configuration is the wireless connection OFF regardless of the communication state with the camera 100.

On the other hand, when the wireless role configuration indicated by the wireless role switch is not the wireless connection OFF (is the sender or the receiver), the flash controller 311 proceeds with the process to a step S402. In the step S402, the flash controller 311 determines whether the ACC communication with the camera controller 102 is possible as with the step S104. When the ACC communication is possible, the flash controller 311 proceeds with the process to a step S403. On the other hand, when the ACC communication is impossible, the flash controller 311 determines that the flash device 300S is located at a position away from the camera 100 and proceeds with the process to a step S404.

In the step S403, the flash controller 311 sets the wireless role configuration to the sender. Therefore, the wireless role configuration is set to the sender regardless of the wireless role configuration indicated by the wireless role switch (even if the wireless role switch is the receiver).

In the step S404, the flash controller 311 sets the wireless role configuration to the wireless role configuration indicated by the wireless role switch. Therefore, when the current wireless role configuration is different from the wireless role configuration indicated by the wireless role switch, the wireless role configuration indicated by the wireless role switch is restored.

As described above, the automatic setting of the wireless role in the case of having the mechanical switch for determining the wireless role configuration reduces the time and effort of the user by supporting the setting so that the flash device 300S connected to and communicating with the camera 100 automatically becomes the sender.

According to the present embodiment, in the case where the wireless role configuration indicated by the wireless role switch is the sender or the receiver, the flash controller 311 sets the wireless role configuration to the sender at the time of confirming the start of communication with the camera 100. In addition, in the case where the wireless role configuration indicated by the wireless role switch is the sender or the receiver, the flash controller 311 sets the wireless role configuration to the wireless role configuration indicated by the wireless role switch at the time of confirming the release of the communication with the camera 100. This can achieve the same effect as that of the first embodiment in terms of reducing the burden of the role setting for the wireless communication.

Unless the wireless role configuration is the wireless connection OFF, the wireless role configuration becomes the sender when the start of the ACC communication is confirmed (S402 to S403). On the other hand, unless the wireless role configuration is the wireless connection OFF, the wireless role configuration is set to the wireless role configuration indicated by the wireless switching function when the release of the ACC communication is confirmed (S402 to S404). From this viewpoint, the burden of the role setting related to the wireless communication can be reduced.

Note that, regardless of the presence or absence of the wireless role switch, the wireless role configuration may be the sender at the time of confirming the start of the ACC communication. Further, the wireless role configuration may be the receiver at the time of confirming the release of the ACC communication.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-006637, filed Jan. 19, 2024, which is hereby incorporated by reference herein in its entirety.

What is claimed is:

1. A flash light emitting device detachable from an image capturing apparatus, the flash light emitting device comprising:
a light emitting unit configured to emit flash light;
at least one processor; and
a memory coupled to the processor storing instructions that, when executed by the processor, cause the processor to function as:
a first communication unit configured to communicate with the image capturing apparatus via a mount;
a second communication unit configured to wirelessly transmit and receive control information to and from another flash light emitting device; and
a setting unit configured to set, as a role configuration related to wireless communication by the second communication unit, any one of a sender that transmits the control information to the other flash light emitting device, a receiver that receives the control information from the other flash light emitting device, and communication OFF that does not perform wireless communication with the other flash light emitting device,
wherein the setting unit changes the role configuration to the sender in a case where the role configuration is the receiver and it is determined that the communication with the image capturing apparatus by the first communication unit is possible, and changes the role configuration to the receiver in a case where the role configuration is the sender and it is determined that the communication with the image capturing apparatus by the first communication unit is impossible.

2. The flash light emitting device according to claim 1, wherein the setting unit maintains the role configuration as-is in a case where the role configuration is the sender or the communication OFF and it is determined that the communication with the image capturing apparatus by the first communication unit is possible.

3. The flash light emitting device according to claim 1, wherein the setting unit maintains the role configuration as-is in a case where the role configuration is the receiver or the communication OFF and it is determined that the communication with the image capturing apparatus by the first communication unit is impossible.

4. The flash light emitting device according to claim 1, further comprising a memory unit that stores a change history of the role configurations,
wherein the setting unit is capable of setting the role configuration based on a user instruction, and
wherein the setting unit maintains the role configuration indicated by a latest record in the change history in a case where the latest record in the change history stored in the memory unit is set based on the user instruction and change in a communication state with the image capturing apparatus by the first communication unit is confirmed.

5. The flash light emitting device according to claim 1, wherein the setting unit sets the role configuration to the sender in a case where pairing is instructed during communication with the image capturing apparatus.

6. The flash light emitting device according to claim 1, wherein the setting unit sets the role configuration to the receiver in a case where pairing is instructed during non-communication with the image capturing apparatus.

7. A flash light emitting device detachable from an image capturing apparatus, the flash light emitting device comprising:
a light emitting unit configured to emit flash light;
at least one processor; and
a memory coupled to the processor storing instructions that, when executed by the processor, cause the processor to function as:
a first communication unit configured to communicate with the image capturing apparatus via a mount;
a second communication unit configured to wirelessly transmit and receive control information to and from another flash light emitting device;
a setting unit configured to set, as a role configuration related to wireless communication by the second communication unit, any one of a sender that transmits the control information to the other flash light emitting device, a receiver that receives the control information from the other flash light emitting device, and communication OFF that does not perform wireless communication with the other flash light emitting device; and
an operation member operated by a user to manually set the role configuration,
wherein the setting unit sets the role configuration to the sender in a case where the role configuration indicated by the operation member is the sender or the receiver and it is determined that the communication with the image capturing apparatus by the first communication unit is possible.

8. The flash light emitting device according to claim 7, wherein the setting unit sets the role configuration indicated by the operation member in a case where the role configuration indicated by the operation member is the sender or the receiver and the communication with the image capturing apparatus by the first communication unit is impossible.

9. The flash light emitting device according to claim 7, wherein the setting unit sets the role configuration to the communication OFF regardless of the communication state with the image capturing apparatus in a case where the role configuration indicated by the operation member is the communication OFF.

10. A flash light emitting device detachable from an image capturing apparatus, the flash light emitting device comprising:
a light emitting unit configured to emit flash light;
at least one processor; and
a memory coupled to the processor storing instructions that, when executed by the processor, cause the processor to function as:
a first communication unit configured to communicate with the image capturing apparatus via a mount;
a second communication unit configured to wirelessly transmit and receive control information to and from another flash light emitting device; and
a setting unit configured to set, as a role configuration related to wireless communication by the second communication unit, any one of a sender that transmits the control information to the other flash light emitting device, a receiver that receives the control information from the other flash light emitting device, and communication OFF that does not perform wireless communication with the other flash light emitting device,
wherein the setting unit sets the role configuration to the sender in a case where it is determined that the communication with the image capturing apparatus by the first communication unit is possible.

11. A control method for a flash light emitting device that is detachable from an image capturing apparatus, includes a light emitting unit configured to emit flash light, a first communication unit configured to communicate with the image capturing apparatus via a mount, and a second communication unit configured to wirelessly transmit and receive control information to and from another flash light emitting device, and is capable of setting, as a role configuration related to wireless communication by the second communication unit, any one of a sender that transmits the control information to the other flash light emitting device, a receiver that receives the control information from the other flash light emitting device, and communication OFF that does not perform wireless communication with the other flash light emitting device, the control method comprising:
determining whether the first communication unit is capable of communicating with the image capturing apparatus;
changing the role configuration to a sender in a case where the role configuration is the receiver and the communication is determined to be possible; and
changing the role configuration to the receiver in a case where the role configuration is the sender and the communication is determined to be impossible.

12. A control method for a flash light emitting device that is detachable from an image capturing apparatus, includes a light emitting unit configured to emit flash light, a first communication unit configured to communicate with the image capturing apparatus via a mount, a second communication unit configured to wirelessly transmit and receive control information to and from another flash light emitting device, and an operation member operated by a user to manually set a role configuration related to wireless communication by the second communication unit, and is capable of setting, as the role configuration, any one of a sender that transmits the control information to the other flash light emitting device, a receiver that receives the control information from the other flash light emitting device, and communication OFF that does not perform wireless communication with the other flash light emitting device, the control method comprising:
determining whether the first communication unit is capable of communicating with the image capturing apparatus; and
setting the role configuration to the sender in a case where the role configuration indicated by the operation member is the sender or the receiver and the communication is determined to be possible.

13. A control method for a flash light emitting device that is detachable from an image capturing apparatus, includes a light emitting unit configured to emit flash light, a first communication unit configured to communicate with the image capturing apparatus via a mount, and a second communication unit configured to wirelessly transmit and receive control information to and from another flash light emitting device, and is capable of setting, as a role configuration related to wireless communication by the second communication unit, any one of a sender that transmits the control information to the other flash light emitting device, a receiver that receives the control information from the other flash light emitting device, and communication OFF that does not perform wireless communication with the other flash light emitting device, the control method comprising:
determining whether the first communication unit is capable of communicating with the image capturing apparatus; and
setting the role configuration to the sender in a case where the communication is determined to be possible.

14. A non-transitory computer-readable storage medium storing a control program causing a computer to execute a control method for a flash light emitting device that is detachable from an image capturing apparatus, includes a light emitting unit configured to emit flash light, a first communication unit configured to communicate with the image capturing apparatus via a mount, and a second communication unit configured to wirelessly transmit and receive control information to and from another flash light emitting device, and is capable of setting, as a role configuration related to wireless communication by the second communication unit, any one of a sender that transmits the control information to the other flash light emitting device, a receiver that receives the control information from the other flash light emitting device, and communication OFF that does not perform wireless communication with the other flash light emitting device, the control method comprising:
determining whether the first communication unit is capable of communicating with the image capturing apparatus;
changing the role configuration to a sender in a case where the role configuration is the receiver and the communication is determined to be possible; and
changing the role configuration to the receiver in a case where the role configuration is the sender and the communication is determined to be impossible.

15. A non-transitory computer-readable storage medium storing a control program causing a computer to execute a control method for a flash light emitting device that is detachable from an image capturing apparatus, includes a light emitting unit configured to emit flash light, a first communication unit configured to communicate with the image capturing apparatus via a mount, a second communication unit configured to wirelessly transmit and receive control information to and from another flash light emitting device, and an operation member operated by a user to manually set a role configuration related to wireless communication by the second communication unit, and is capable of setting, as the role configuration, any one of a sender that transmits the control information to the other flash light emitting device, a receiver that receives the control information from the other flash light emitting device, and communication OFF that does not perform wireless communication with the other flash light emitting device, the control method comprising:
determining whether the first communication unit is capable of communicating with the image capturing apparatus; and
setting the role configuration to the sender in a case where the role configuration indicated by the operation member is the sender or the receiver and the communication is determined to be possible.

16. A non-transitory computer-readable storage medium storing a control program causing a computer to execute a control method for a flash light emitting device that is detachable from an image capturing apparatus, includes a light emitting unit configured to emit flash light, a first communication unit configured to communicate with the image capturing apparatus via a mount, and a second communication unit configured to wirelessly transmit and receive control information to and from another flash light emitting device, and is capable of setting, as a role configuration related to wireless communication by the second communication unit, any one of a sender that transmits the control information to the other flash light emitting device, a receiver that receives the control information from the other flash light emitting device, and communication OFF that does not perform wireless communication with the other flash light emitting device, the control method comprising:
determining whether the first communication unit is capable of communicating with the image capturing apparatus; and
setting the role configuration to the sender in a case where the communication is determined to be possible.
